(19) United States
(12) Patent Application Publication
(10) Pub. No.: US 2020/0122305 A1
(43) Pub. Date: Apr. 23, 2020

(54) TORQUE WRENCH AND REACTION ARM ASSEMBLY

(71) Applicant: Hire Torque Limited, Northumberland (GB)

(72) Inventor: Stephen Quicke, Northumberland (GB)

(21) Appl. No.: 16/477,990

(22) PCT Filed: Jan. 15, 2018
(86) PCT No.: PCT/GB2018/050102

§ 371 Date: Jul. 15, 2019

(30) Foreign Application Priority Data
Jan. 13, 2017 (GB) 1700597.6

(51) Int. Cl. B25B 23/00

(52) U.S. Cl. CPC B25B 23/0078; B25B 23/145; B25B 23/0007

(57) ABSTRACT

A torque wrench assembly comprises a torque wrench and a reaction arm and locking means for locking together the torque wrench and the reaction arm. The locking means comprises a connection member located on the torque wrench; an opening on the reaction arm for receipt of the connection member of the torque wrench; a locking member slidably mounted in a channel on the reaction arm, the locking member including an aperture sized to allow the connection member to pass therethrough; and biasing means arranged to bias the locking member into a position wherein the aperture is partially aligned with the opening. The connection member has an insertion end for insertion into the opening of the reaction arm, and immediately adjacent the insertion end is a recess. The recess is shaped to receive a part of the locking member.

### FIELD OF THE INVENTION

The present invention relates to torque wrenches and in particular a type of torque wrench mounting a reaction arm and a quick-release mechanism for locking together the torque wrench and reaction arm.

### BACKGROUND OF THE INVENTION

Hydraulic torque wrenches are used widely, particularly in the oil and gas industries. Torque wrenches require some form of reaction member or reaction arm that engages with an immovable object to prevent the wrench from spinning about the component that is to be tightened or loosened.

GB2524825 describes a torque wrench which couples to a reaction arm using a quick release mechanism incorporating ball bearings which locate in a groove.

This type of quick release mechanism requires the user to depress a button before connecting the reaction arm to the wrench. If the button is not depressed prior to assembly this leads to improper assembly and/or damage to the component parts. We have also found that this prior art locking mechanism doesn't always engage properly.

It would therefore be desirable to provide an improved torque wrench and an improved quick release mechanism for connection with a reaction arm.

### SUMMARY OF THE INVENTION

According to the invention there is provided a torque wrench assembly comprising a torque wrench and a reaction arm and locking means for locking together the torque wrench and the reaction arm, wherein the locking means comprises:
a connection member located on either one of the torque wrench or the reaction arm;
an opening on a respective other one of the torque wrench and the reaction arm for receipt of the connection member of the torque wrench and a locking member slidably mounted in a channel on said torque wrench or reaction arm, the locking member including an aperture sized to allow the connection member to pass therethrough;
and biasing means arranged to bias the locking member into a position wherein the aperture is partially aligned with the opening;
wherein the connection member includes a recess, and wherein both the locking member and the recess are shaped and dimensioned such that the locking member is a sliding fit in the recess.

Insertion of the connection member into the opening causes the locking means to slide inwards, against the force of the biasing means. This aligns the aperture with the opening and allows the insertion end of the connection member to pass through the aperture. Once the insertion end of the connection member has passed through aperture, the locking means is biased into a locked position where it engages with the recess on the connection member such that the aperture is no longer aligned with the opening

The aperture of the locking member preferably has a chamfered edge.

The insertion end of the connection member is preferably tapered in shape.

The biasing means may be a spring.

The reaction arm may further comprise a hole into which the connection member locates.

Preferably, the connection member is located on the torque wrench and the locking member is located on the reaction arm.

### BRIEF DESCRIPTION OF THE DRAWINGS

In the Drawings, which illustrate the prior art and preferred embodiments of a torque wrench according to the invention:

FIG. 1 is a schematic representation of a hydraulic torque wrench and a reaction arm prior to assembly;

FIG. 2 is a schematic representation of the assembled hydraulic torque wrench and a reaction arm of FIG. 1;

FIG. 3 is a schematic representation of the assembled hydraulic torque wrench and a reaction arm of FIG. 2, shown with the end plate of the reaction arm removed;

FIG. 4 is a vertical cross-sectional view of the torque wrench assembly shown in FIG. 2;

FIG. 5 is a vertical cross-sectional view of the torque wrench assembly of FIG. 2 shown just prior to the engagement of the locking member;

FIG. 6a is a close up schematic representation of the locking means of the torque wrench assembly shown just prior to the engagement of the locking member;

FIG. 6b is a close up schematic representation of the locking means of the torque wrench assembly shown after the engagement of the locking member;

FIG. 7a is a schematic representation of a locking member component part of a reaction arm;

FIG. 7b is a cross-sectional view of the locking member of FIG. 7a, along the line A-A and

FIG. 8 is a schematic representation of the reaction arm of FIG. 1 with the end plate removed.

### DETAILED DESCRIPTION OF THE PRIOR ART AND PREFERRED EMBODIMENTS OF THE INVENTION

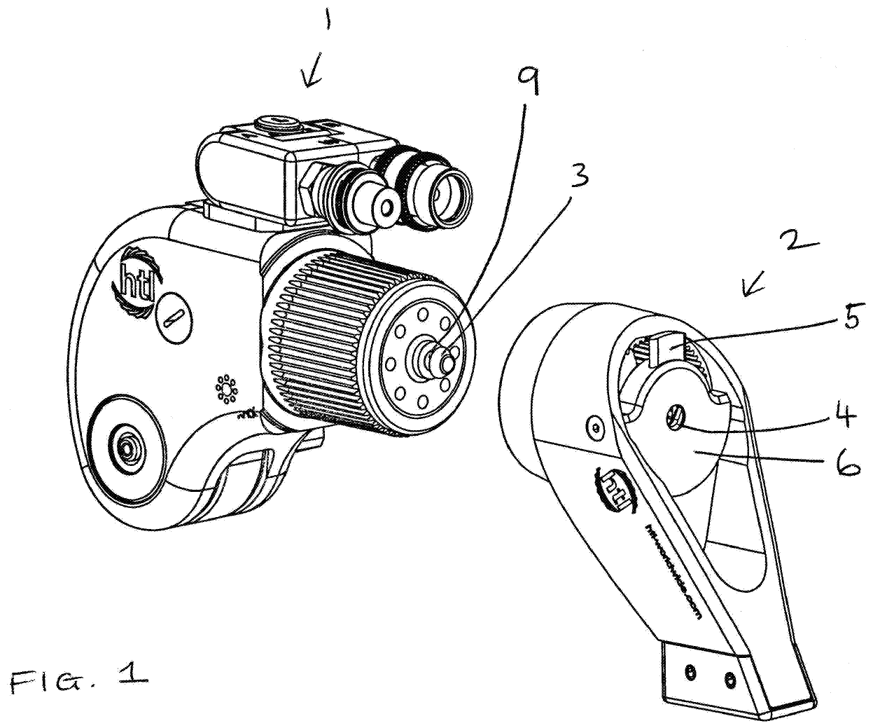

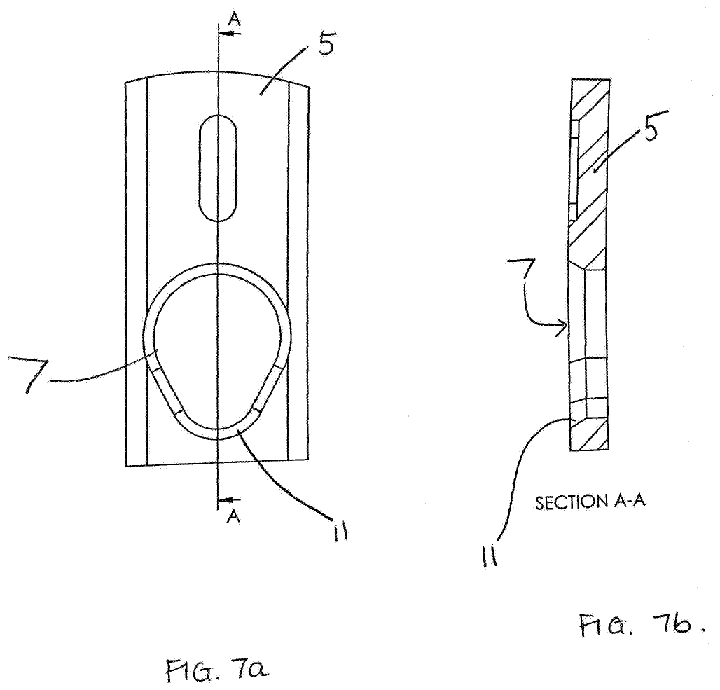

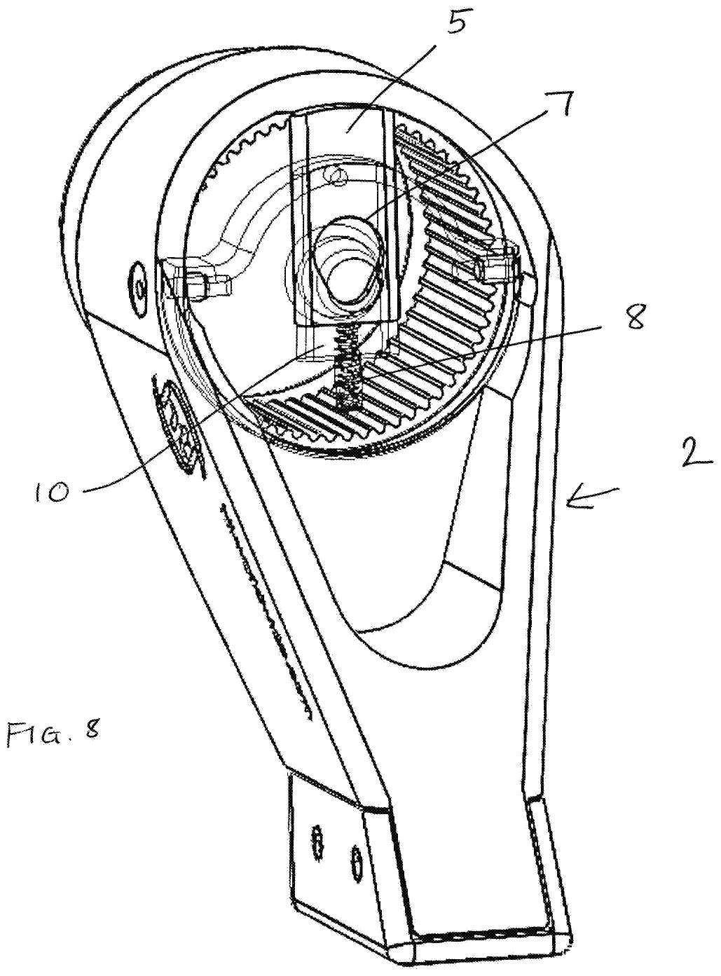

FIG. 1 illustrates a torque wrench 1 and a reaction arm 2. The torque wrench 1 is provided with a connection member 3 and the reaction arm 2 includes an opening 12 (see FIG. 7a) for receiving the connection member 3. In the illustrated embodiment the reaction arm 2 also includes a back plate 6 with a hole 4 therein, into which the connection member 3 locates, although this is not essential, for example a hollow portion inside the reaction arm would suffice for receiving the end of the connection member 3. The reaction arm 2 includes a locking member 5 which is slidably mounted in a channel 10. The locking member 5 includes an aperture 7 sized to allow the connection member 3 to pass therethrough.

As shown in FIGS. 7a and 7b, the edge 11 of the aperture 7 is preferably chamfered. The end of the connector member 3 is preferably tapered as illustrated.

The locking member 5 has an upper end which protrudes from the reaction arm 2, as shown in the drawings, and a lower end which is connected to a spring 8. The spring is arranged to bias the locking member 5 towards the reaction arm 2. When the locking member 5 is at rest the aperture 7 is partially overlaps with opening for receiving the connection member 3.

The locking member 5 is shown in more detail in FIGS. 7a and 7b. The aperture is preferably roughly the shape of an inverted pear, with a first region of larger diameter and a second region of smaller diameter. The edge 11 of the aperture 7 with which the connection member 3 first engages is preferably chamfered.

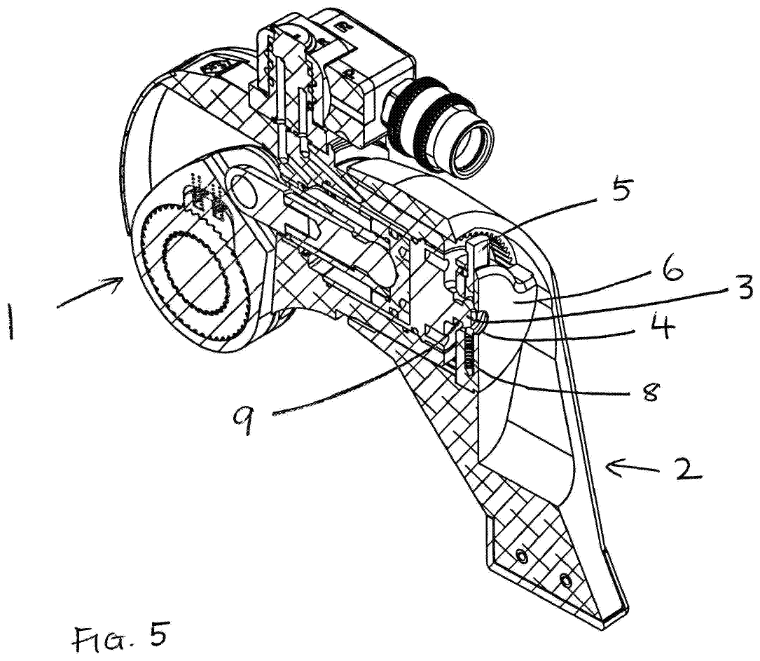

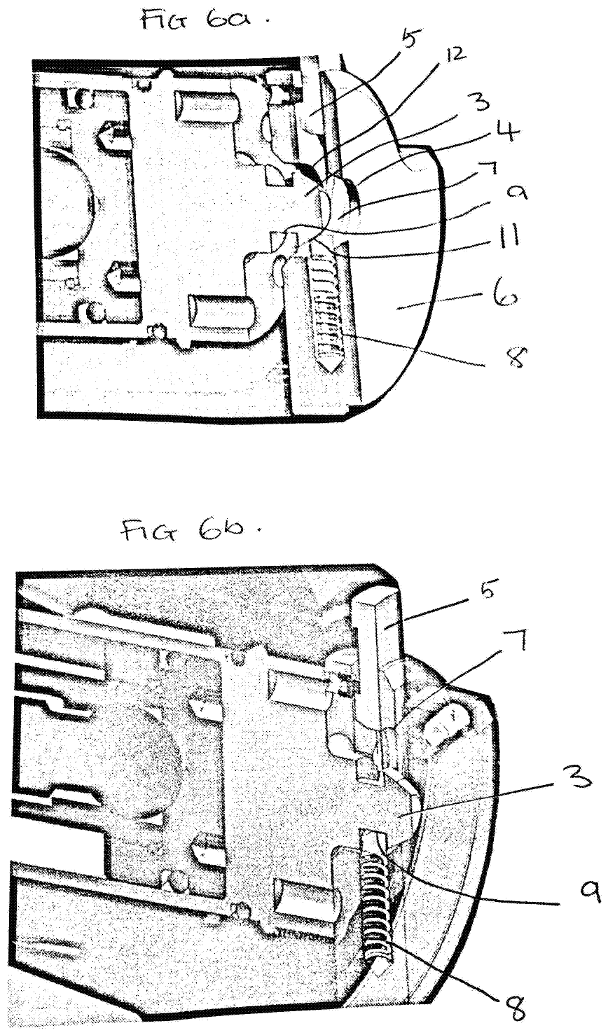

As shown in FIGS. 5 and 6a, when the connection member 3 of the torque wrench 1 is pushed into the opening 12 of the reaction arm 2, the end of the connection member 3 pushes down on the chamfered edge 11 of the aperture 7 which then pushes the locking member 5 downwards against the force of the spring 8. The part of the aperture 7 with larger diameter is now aligned with the opening 12, allowing the end of the connection member 3 to pass through the aperture 7 and locate in the hole 4 in the back plate 6. The connection member 3 includes a recess 9 located adjacent to the tapered end, the recessed part 9 having a diameter which is smaller than the insertion end of the connection member 3 and shaped to receive part of the locking member 5.

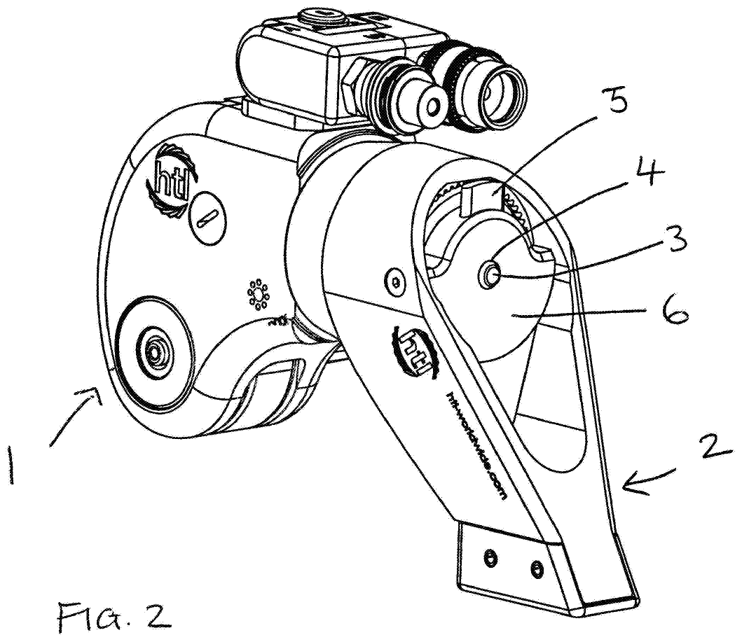

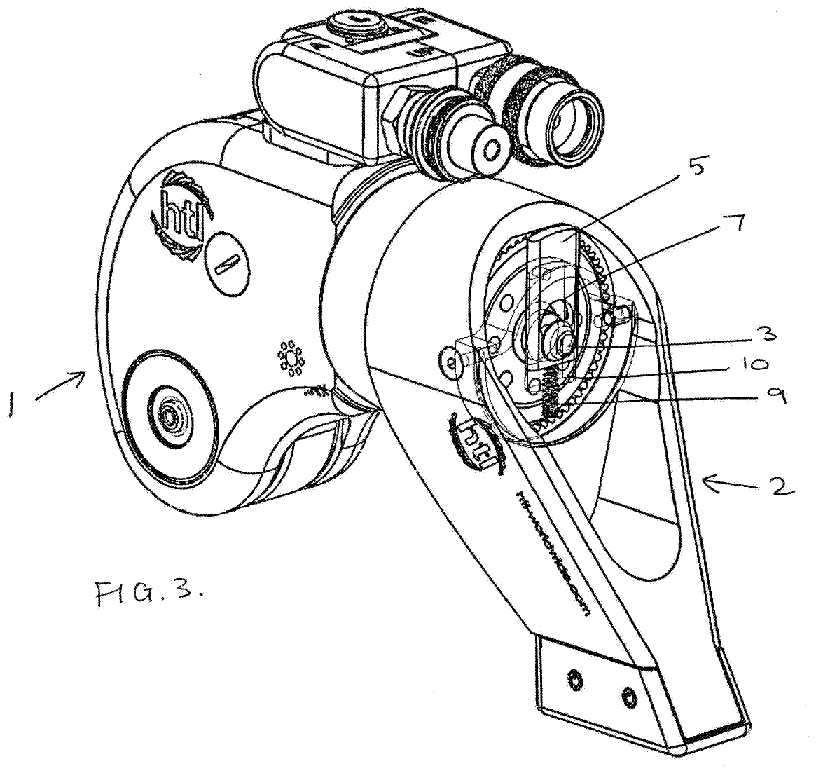

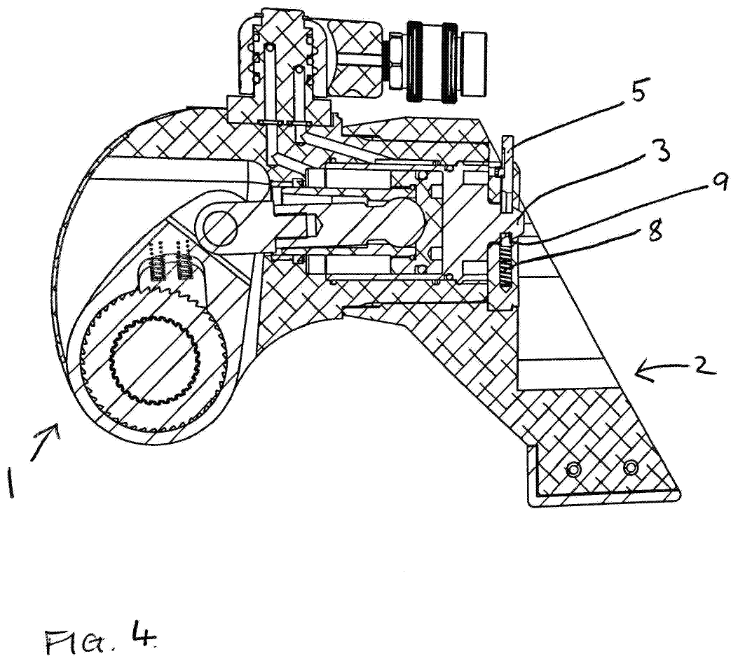

As shown in FIGS. 3, 4 and 6b, once the tapered end of the connection member 3 has passed through the aperture 7 of the locking member 5, the locking member 5 springs up automatically and locks into the recess 9 behind the end of the connection member 3 due to the force exerted by the spring. The torque wrench 1 and reaction arm 2 are now securely locked together since the aperture 7 of the locking member is not aligned with the opening 12 on the reaction arm and the two devices cannot be unlocked without some manual intervention. FIG. 2 illustrates the two devices locked together.

To unlock the two devices, the user simply presses down on the upper end of the locking member 5, and this causes the locking member 5 to slide towards the spring and causes the aperture 7 to fully align with the first opening allowing the connection member 3 of the torque wrench 1 to be withdrawn from the reaction arm 2, uncoupling the two devices.

The torque wrench assembly of the invention provides an improved mechanism for securely locking together a torque wrench and a reaction arm without the requirement for user input prior to assembly of the two devices.

1. A torque wrench assembly comprising a torque wrench and a reaction arm and locking means for locking together the torque wrench and the reaction arm, wherein the locking means comprises:
a connection member located on either one of the torque wrench or the reaction arm;
an opening on a respective other one of the torque wrench and the reaction arm for receipt of the connection member and a locking member slidably mounted in a channel on said torque wrench or reaction arm, the locking member including an aperture sized to allow the connection member to pass therethrough;
and biasing means arranged to bias the locking member into a position wherein the aperture of the locking member is partially aligned with the opening;
wherein the connection member includes a recess, and wherein both the locking member and the recess are shaped and dimensioned such that the locking member is a sliding fit in the recess.

2. A torque wrench assembly according to claim 1, wherein the aperture of the locking member has a chamfered edge.

3. A torque wrench assembly according to claim 1, wherein the connection member has and insertion end for insertion into the opening and the insertion end is tapered in shape.

4. A torque wrench assembly according to claim 1, wherein the biasing means is a spring.

5. A torque wrench assembly according to claim 1, wherein the connection member is located on the torque wrench and the locking member is located on the reaction arm.
